(19) United States
(12) Patent Application Publication
(10) Pub. No.: US 2011/0185920 A1
(43) Pub. Date: Aug. 4, 2011

(54) SYSTEM FOR STORING THE DRIVE SHAFT OF A FOOD PROCESSOR

(75) Inventors: Aleksander Oblak, Recica ob Savinji (SI); Jurij Pesec, Slowenien (SI); Roman Sabec, Smartno (SI)

(73) Assignee: BSH BOSCH UND SIEMENS HAUSGERATE GMBH, Munich (DE)

(21) Appl. No.: 12/672,281

(22) PCT Filed: Jul. 30, 2008
(86) PCT No.: PCT/EP2008/059982

§ 371 Date: Feb. 5, 2010

(30) Foreign Application Priority Data
Aug. 14, 2007 (DE) 10 2007 038 371.3

(51) Int. Cl. A47J 43/08; A47J 43/07

(52) U.S. Cl. 99/485

(57) ABSTRACT

A system for the alternate support of a first drive shaft or a second drive shaft to rotationally drive a processing tool of a food processor for preparing foods. The food processor has a preparation container, and the system includes a passage through which the first drive shaft or the second drive shaft protrudes from the outside into the preparation container in order to drive the processing tool in a rotatable manner. The passage has a first bearing to support the first drive shaft, and the system further includes an adapter which is inserted into the passage and which has a second bearing to support the second drive shaft.

### BACKGROUND OF THE INVENTION

The present invention relates to a system for alternate support of a first or a second drive shaft used to drive a rotating processing tool of a food processor, as claimed in the preamble of claim 1.

### PRIOR ART

Numerous types of food processors are known from the prior art, with which a drive shaft protrudes from the outside through a passage into a preparation container, where it drives a processing device, for instance dough hooks, in a rotatable manner. For instance, the unexamined German publication DE 1 891 126 A1 discloses a mixing bowl, which has a central pillar which extends upwards from the base of the mixing bowl, in the center of which is located the drive shaft. The shaft head protruding from the pillar is provided with a square end, to which a mixer can be attached. For the rotatable support of the drive shaft in the mixer, provision is made for a nut which can be detachably screwed to the pillar. A spring washer is also used to safeguard the shaft inside the nut against axial displacement. The nut can be easily gripped by hand so that the shaft can be released from the pillar and thus from the mixing bowl for cleaning purposes.

With food processors, different types of drive shaft are used depending on the field of application. Drive shafts made of metal are preferred for instance, if a larger torque is to be transferred to the processing tool. If only smaller torques are to be transferred, hollow shafts made of plastic are by contrast frequently used. On account of different diameters, the different shafts frequently have to be supported in the passage using different means so that it is not easily possible to use the same passage with different shafts.

If the passage is part of the preparation container, it may therefore be necessary to provide a preparation container which is adapted hereto for each shaft. This may involve additional costs in terms of manufacture, storage and marketing of the different preparation containers. Furthermore, the usefulness of the preparation container may as a result also be reduced such that it can only be used with specific shafts and therefore only with specific food processors and processing tools.

Experience has also shown that bearings for shafts with a small diameter can only be manufactured with difficulty in a passage using the preferred injection molding method, particularly if the passage has an elongated form, e.g. a hollow supporting form, because the minimal diameter makes it difficult to ensure an adequate cooling of the injection mould.

### The Object Underlying the Invention

The object underlying the invention is to provide an improved system, in which different drive shafts, in particular drive shafts with different diameters, can be inserted in the same passage. The system should be easy to operate and simple and cost-effective to manufacture.

### Inventive Solution

To achieve the object, the present invention proposes a system with the features of claim 1.

The inventive adapter enables the passage to be adjusted such that it cannot be used with a first drive shaft but instead also with a second drive shaft which differs from the first. It is therewith possible to avoid different passages having to be manufactured for different drive shafts, thereby making particular savings on tool costs. Furthermore, the known manufacturing difficulties can be avoided when embodying a bearing with a minimal diameter directly into the passage by means of the adapter.

### Preferred Embodiment of the Invention

Advantageous embodiments and developments, which can be used individually or in combination with one another, form the subject matter of the dependent claims.

In a preferred embodiment of the invention, the passage is a hollow stub, through which the first or second drive shaft can pass. The first bearing is then preferably arranged on or in the vicinity of an end of the hollow stub. To mount the first drive shaft in as stable a manner as possible, in a preferred embodiment of the invention, the first bearing is on the end of the hollow stub which faces the processing tool during operation.

The adapter can preferably be inserted into the first bearing. With this embodiment of the invention, it is advantageously achievable for the second bearing to be attachable to the same section of the passage in which the first bearing is also located, i.e. on the end of the hollow stub which faces the processing tool during operation. Advantageously, both drive shafts can be mounted on the point which is most favorable in terms of their function.

In a preferred embodiment of the invention, the passage forms part of the preparation container. With this embodiment of the invention, a preparation container can be advantageously provided, which can be used with at least two different drive shafts. This prevents different preparation containers having to be manufactured for different drive shafts. Furthermore, preparation containers with bearings for shafts with a minimal diameter can also be easily provided. The passage is preferably arranged in a base of the preparation container, particularly preferably as a hollow stub, which protrudes from the base of the preparation container into the preparation container. An opening is located at the end of the preferred passage, through which the head of a drive shaft can enter, so that a processing tool can be coupled thereto.

The preparation container and the hollow stub are preferably embodied in one piece, preferably made of plastic. They can however also be formed from two parts, preferably from different materials. A preparation container dish can be made from metal for instance, preferably from steel sheet, by means of deep drawing for instance and the passage made from plastic, preferably using an injection molding method. With this inventive embodiment, a hollow stub is preferably embodied in the dish, which extends from the base of the dish into the inside of the container and can be inserted into the passage embodied similarly as a hollow stub. In this case, the shaft can preferably extend through an opening in the passage and a further opening in the dish into the latter.

Other embodiments of the invention are however conceivable, in which the passage is not part of the preparation container, but is instead another part, for instance a cover of the preparation container, with the drive shaft then preferably extending through the passage of the cover from above into the preparation container, in order to drive a tool.

In a preferred embodiment of the invention, one side of the passage, which faces the processing tool during operation, has an attachment, on which a ring gear is formed. A toothed gear of the processing tool can preferably run in the ring gear, in order to rotate this about a further axis during rotation. The ring gear is preferably connected in a rotationally secure fashion to the rest of the passage, e.g. with a spring catch, by means of a thread or by means of adhesion. In one embodiment of the invention, the first bearing is embodied in one piece with the attachment.

In a preferred embodiment of the invention, the bearing diameter of the second bearing is smaller than the bearing diameter of the first bearing. In this way shafts with a different diameter can be advantageously mounted in the passage. In particular, drive shafts made of metal typically have a smaller diameter than drive shafts made of plastic, which are usually embodied as hollow shafts.

At least one of the bearings, preferably both bearings, are particularly preferably embodied as radial bearings. It is in this way advantageously possible for the shaft and thus the tool to rotate in a stable fashion about a fixed axis of rotation, in particular also if radial forces produced by products to be prepared in the preparation container act on the tool and thus on the drive shaft. In one embodiment of the invention, one of the bearings or both bearings also act as an axial bearing. This may then be particularly advantageous if axial forces also act on the tool and thus on the shaft when preparing the product. For instance, an upwardly directed force can act on the tool when kneading dough for instance. It is also conceivable for the passage and/or the adapter adjacent to a radial bearing to be equipped with an additional axial bearing.

At least one of the bearings, preferably all bearings, are embodied as sliding bearing. To this end, the bearings preferably comprise a sliding bearing socket with a sliding surface in the form of a hollow cylinder or a hollow cylinder section. The bearing surfaces preferably consist of plastic. Preferred bearings are embodied in one piece with the passage and from a material which is uniform herewith. The preparation container, passage and first bearing are particularly preferably formed in one piece from a uniform material. Alternatively to an embodiment of the bearing as a sliding bearing, other bearing types are also conceivable, for instance roller bearings, in particular ball bearings or magnetic bearings.

The heads of drive shafts, particularly those made of metal, are frequently equipped with radially protruding pins, so that a rotationally secure connection can be produced between the shaft and the coupling section of a tool. The bearing surface of at least one of the bearings, preferably the second bearing, is therefore preferably interrupted with a groove, which runs across the whole length of the bearing (relative to its axial direction) so that pins protruding from the shaft can pass through the bearing if the shaft is guided through the bearing. The preferred groove runs in an axial direction relative to the bearing. Two or more grooves are particularly preferably provided, at least equating to the number of pins in the shaft, which are to be guided through the bearing. The grooves are particularly preferably arranged at equal distances from one another.

The preferred adapter includes two adapter parts, which can enclose a fixing device of the passage between them in order to fix the adapter in the passage. In this way, the preferred adapter can be securely attached in the passage. The fixing device is preferably a flange, which forms an opening of the passage, through which the shaft enters or leaves the passage. The adapter is preferably fixed by connecting the adapter parts to the fixing device. With this embodiment of the invention, it is particularly achievable for the adapter parts to be fixed in an axial direction. In a preferred embodiment, the adapter is also fixed in the radial direction.

Preferably one of the two adapter parts be attached to the fixing device from one side of the passage and the other from the other side of the passage in order to enclose the fixing device between the adapter parts. In this case, when viewed in the axial direction of the second drive shaft, one of the two adapter parts preferably engages with the fixing device from the one side and the other adapter part from the other side of the passage.

The adapter parts preferably include elements of a bayonet fixing, a screw plug or a spring catch, in order to connect the adapter parts to one another. This enables the adapter to be attached to the passage without a tool. In particular, a user of the system can easily equip the passage for use with other drive shafts for instance. It is an achievable advantage of this embodiment of the invention that a user can adjust the same mixing bowl or the same cover by selecting the suitable shaft for the tool preferred by him/her for a certain process. As a result, he can access a larger selection of tools, for instance such tools which are generally operated with plastic shafts on account of a relatively minimal transmitted torque and such tools which are usually provided for metal shafts on account of a high load on the axis. It is however also conceivable for instance to embody adapter parts such that they can be glued and/or screwed using screws.

A preferred system also includes a first drive shaft, which can be stored in the first bearing such that it protrudes through the passage into the preparation container. The first drive shaft is preferably a hollow shaft, particularly preferably made of plastic. Furthermore, the preferred system also includes a second drive shaft, which can be stored in the second bearing in the case of the adapter used in the passage, so that it protrudes through the passage into the preparation container. The second drive shaft is preferably metal, particularly preferably steel or aluminum. The preferred shafts have a shaft head, to which a coupling section of a processing tool can be attached in a rotationally secure fashion. Different processing tools can preferably be coupled to the shafts, for instance dough hooks, whisks, mixing tools, cutting tools or reaming tools.

### BRIEF DESCRIPTION OF THE DRAWINGS

The invention is described in more detail below with reference to schematic drawings on the basis of an exemplary embodiment, in which;

FIG. 1 shows a cross-sectional view of a first embodiment of the inventive system, in which the passage is embodied as a hollow stub-type part of the processing container; and

FIG. 2 shows a cross-sectional view of a further embodiment of the invention, in which the passage is embodied as a hollow stub, which can be inserted into a hollow stub-type protuberance of the dish of the preparation container.

### DETAILED DESCRIPTION ON THE BASIS OF TWO EXEMPLARY EMBODIMENTS

With the subsequent description of two preferred embodiments of the present invention, the same reference characters indicate identical or comparable components.

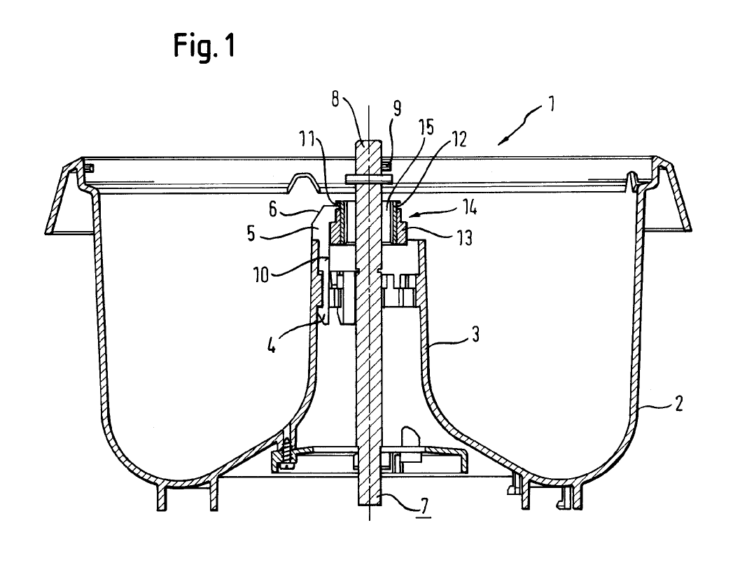

The system 1 in FIG. 1 includes a dish-type preparation container 2, from the base of which protrudes a hollow stub-type passage 3 into the inside of the container. The end of the hollow stub is formed by an attachment 5 with ring gear 6 connected to the rest of the passage 3 by means of spring catches 4. A toothed wheel (not shown) of the processing tool (not shown) can run in the ring gear % in order to rotate a part of a processing tool using a drive shaft, for instance the second drive shaft 7. To drive the processing tool, the second drive shaft 7 comprises a shaft head 8, from which a pin 9 protrudes radially in order to ensure a rotationally secure connection with the tool.

The inner surfaces of the attachment 5 of the passage 3 form a cylindrical surface 10, into which a first drive shaft (not shown), preferably a hollow shaft made of plastic, can be mounted radially, with the longitudinal axis of the drive shaft running in parallel to the longitudinal axis of the passage 3.

A flange-type fixing device 11 forms the seal of the attachment on the tool side, said fixing device enclosing the adapter parts 12 and 13 of an adapter 14 between them so as to fix the adapter to the passage. The adapter consists of an inner adapter part 12 and an outer adapter part 13, which can be pushed into one another and secured with screws. The inner adapter part has a hollow cylindrical surface on its inside, said hollow cylindrical surface being interrupted by grooves 15 running in the longitudinal direction of the second drive shaft 6. These grooves 15 are provided so that the pins 9 of the shaft 7 can be guided through the adapter 14, if the shaft 6 is inserted into the passage 3, as shown in FIG. 1.

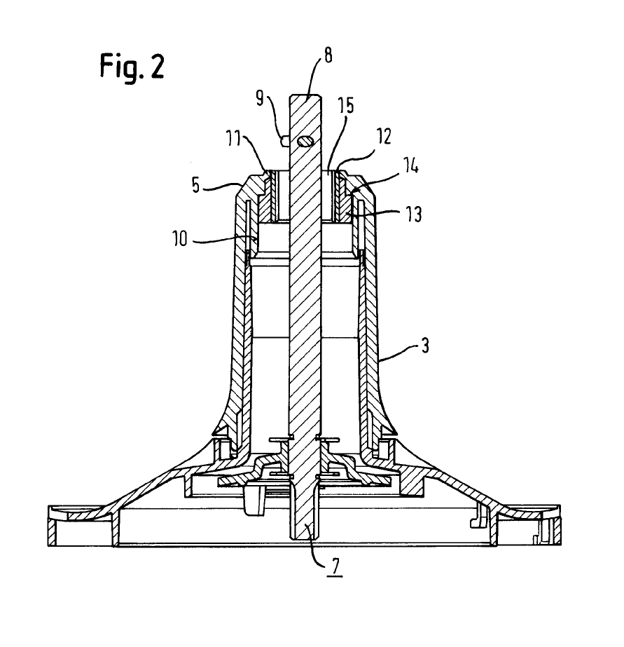

FIG. 2 shows an alternative embodiment of the invention, in which the ring gear 6 is embodied in one piece with the rest of the passage 3. The passage 3 can be inserted into the hollow stub of a steel mixing bowl (not shown) embodied in a similar fashion to the preparation container 2. The cylindrical internal surface 10 of the upper section of the passage 3, which supports the ring gear 6 on the outside, also forms a sliding bearing for a first drive shaft with a large diameter. The adapter 14 is inserted into this sliding bearing, the internal surface of which form bearing surfaces for the shaft 7. A circular fixing device 11, which can enclose the adapter parts 12, 13 between them, forms the seal of the passage 3 on the tool side so as to fix the adapter 14 to the passage 3.

The inventive system 1 enables different drive shafts 7 to be inserted alternately into the passage 3 and therefore a preparation container 2 to be provided for instance which can be operated with different drive shafts 7.

The features disclosed in the preceding description, claims and drawings can be useful both individually and also in any combination in terms of realizing the invention in its different embodiments.

1-15. (canceled)

16. A system for the alternate support of one of a first drive shaft and a second drive shaft to rotationally drive a processing tool of a food processor for preparing foods, the food processor having a preparation container, and the system comprising:
a passage through which the one of the first drive shaft and the second drive shaft protrudes from outside into the preparation container of the food processor in order to drive the processing tool in a rotatable manner, wherein the passage has a first bearing to support the first drive shaft; and
an adapter inserted into the passage and having a second bearing to support the second drive shaft.

17. The system of claim 16, wherein the passage is a hollow stub through which the one of the first drive shaft and the second drive shaft passes.

18. The system of claim 16, wherein the adapter is inserted into the first bearing.

19. The system of claim 16, wherein the passage is part of the preparation container.

20. The system of claim 19, wherein the passage and the preparation container are one piece.

21. The system of claim 16, wherein the passage has an attachment on a side of the passage that faces the processing tool during operation, and wherein the attachment has a ring gear that is formed on the attachment.

22. The system of claim 16, wherein a first bearing diameter of the first bearing is larger than a second bearing diameter of the second bearing.

23. The system of claim 16, wherein at least one of the first bearing and the second bearing is a radial bearing.

24. The system of claim 16, wherein at least one of the first bearing and the second bearing is a sliding bearing.

25. The system of claim 16, further comprising a pin that protrudes radially from the one of the first drive shaft and the second drive shaft, wherein at least one of the first bearing and the second bearing has at least one groove through which the pin is guided.

26. The system of claim 16, wherein the passage has a fixing device, and wherein the adapter has two adapter parts that enclose the fixing device of the passage between the two adapter parts in order to fix the adapter in the passage.

27. The system as claimed in claim 26, wherein one of the two adapter parts is attached to the fixing device from one side of the passage, and wherein the other of the two adapter parts is attached to the fixing device from another side of the passage so as to enclose the fixing device between the two adapter parts.

28. The system of claim 26, wherein the two adapter parts include elements selected from the group consisting of a bayonet fixing, a screw plug, and a spring catch seal in order to connect the two adapter parts to one another.

29. The system of claim 16, wherein the first drive shaft is supported in the first bearing such that the first drive shaft protrudes through the passage into the preparation container.

30. The system of claim 16, wherein, when the adapter is inserted in the passage, the second drive shaft is supported in the second bearing such that the second drive shaft protrudes through the passage into the preparation container.
